(19) United States
(12) Patent Application Publication
(10) Pub. No.: US 2024/0232273 A1
(43) Pub. Date: Jul. 11, 2024

(54) Cluster Search on Maps Applications

(71) Applicant: Google LLC, Mountain View, CA (US)

(72) Inventor: Ovidiu Aurelian Pana, Lakewood, CO (US)

(21) Appl. No.: 18/010,682

(22) PCT Filed: Jul. 5, 2022
(86) PCT No.: PCT/US2022/036106

§ 371 Date: Dec. 15, 2022

(51) Int. Cl. G06F 16/9537; G06F 16/28; G06F 16/29

(52) U.S. Cl. CPC G06F 16/9537; G06F 16/285; G06F 16/29

(57) ABSTRACT

Methods, systems, and apparatus, including computer-readable storage media for clustering points of interest (POIs). A method includes receiving, by one or more processors, a search query for a collection of POIs. The one or more processors may identify one or more locations for each POI in the collection of POIs. Based on the one or more locations for each POI in the collection of POIs, the one or more processors may determine the distances between each POI. Based on the distances between each POI, the one or more processors may determine one or more clusters of POIs. The one or more processors may transmit clustered location data, the clustered location data including, for each of the one or more clusters of POIs, the location data of each POI in the cluster.

### BACKGROUND

Users of mapping services typically use mapping services to identify where points of interest are located. For example, a user new to an area may submit a search query to a mapping service for nearby grocery stores. In response, the mapping service may return a map that identifies the locations of nearby grocery stores. However, when the user also wants to know the location of a grocery store near a gas station, the user will typically need to submit a search query to the mapping service for a gas station or grocery store. After receiving a map showing the location of the gas station or grocery store, the user needs to manually search the map for either a nearby grocery store or gas station. Such a process is cumbersome and time-consuming, especially when a user wants to find multiple points of interest in proximity to one another.

### BRIEF SUMMARY

Aspects of this disclosure are directed to providing clustered search results for different points of interest. One aspect of the disclosure is directed to a method for clustering points of interest (POIs). The method may comprise: receiving, by one or more processors, a search query for a collection of POIs; identifying, by the one or more processors, one or more locations for each POI in the collection of POIs; determining, by the one or more processors, based on the one or more locations for each POI in the collection of POIs, distances between each POI; determining, by the one or more processors, based on the distances between each POI, one or more clusters of POIs; and transmitting, by the one or more processors, clustered location data, the clustered location data including, for each of the one or more clusters of POIs, the location of each POI in the cluster.

Another aspect of the disclosure is directed to a system for clustering points of interest (POIs). The system may comprise one or more processors. The one or more processors may be configured to: receive a search query for a collection of POIs; identify one or more locations for each POI in the collection of POIs; determine, based on the one or more locations for each POI in the collection of POIs, distances between each POI; determine, based on the distances between each POI, one or more clusters of POIs; and transmit clustered location data, the clustered location data including, for each of the one or more clusters of POIs, the location of each POI in the cluster.

Another aspect of the disclosure is directed to a system for clustering points of interest (POIs). The system may comprise one or more processors. The one or more processors may be configured to: receive a search query for a collection of POIs; identify one or more locations for each POI in the collection of POIs; determine, based on the one or more locations for each POI in the collection of POIs, distances between each POI; determine, based on the distances between each POI, one or more clusters of POIs; and transmit clustered location data, the clustered location data including, for each of the one or more clusters of POIs, the location of each POI in the cluster.

Another aspect of the disclosure is directed to a computer-readable storage medium storing instructions executable by one or more processors for performing a method. The method may comprise: receiving a search query for a collection of POIs; identifying one or more locations for each POI in the collection of POIs; determining, based on the one or more locations for each POI in the collection of POIs, distances between each POI; determining, based on the distances between each POI, one or more clusters of POIs; and transmitting clustered location data, the clustered location data including, for each of the one or more clusters of POIs, the location of each POI in the cluster.

In some instances, the search query includes one or more specific POIs or POI categories. In some instances, identifying the one or more locations for each POI in the collection of POIs is limited to a searchable area. In some instance, the searchable area includes geographic areas within a predefined threshold distance from a base location. In some instances, the search query is provided by a user device, and wherein the base location is a location of the user device.

In some instances, prior to identifying the one or more locations for each POI in the collection of POIs, the base location is received. In some instances, prior to identifying the one or more locations for each POI in the collection of POIs, the searchable area is received. In some instances, the searchable area includes a region, country, state, city, town, zip code, or an area drawn on a map. In some instances, the one or more locations for each POI in the collection of POIs is limited to a set amount of locations.

### BRIEF DESCRIPTION OF THE DRAWINGS

FIG. 1 is an example of clustered location data in accordance with aspects of the disclosure.

FIG. 2 is a functional diagram of an example system in accordance with aspects of the disclosure.

FIG. 3 is a pictorial diagram of the example system of FIG. 2.

FIG. 4 is an illustration of the instructions and data within devices of the example system of FIGS. 2 and 3, in accordance with aspects of the disclosure.

FIG. 5 is a flow diagram 500 that illustrates the process for providing clustered location data in accordance with aspects of the disclosure.

FIGS. 6A and 6B are illustrations of an example user interface for querying a user in accordance with aspects of the disclosure.

FIG. 7 is another illustration of POI locations identified by a mapping service in accordance with aspects of the disclosure.

FIG. 8 is an illustration of an example user interface showing clustered location data on a map in accordance with aspects of the disclosure.

FIG. 9 is an illustration of an example user interface showing clustered location data on a map along with POI location information in accordance with aspects of the disclosure.

### DETAILED DESCRIPTION

### Overview

This technology is directed to providing clustered location data for multiple points of interest (POIs) received in a search query. Clustered location data includes the location data for POIs that are in proximity to one another. For example, a user of a mapping service may want to determine the closest location where they can visit a collection of POIs, including a grocery store, a gas station, and a department store. In another example, a user of a mapping service may want to determine the location which requires the shortest amount of time to travel to. This location may be different than the closest location due to traffic conditions, road conditions, weather conditions, etc. To identify the closest location (or location which requires the shortest amount of time to travel to), the user may submit a single search query containing the three POIs (i.e., grocery store, gas station, and department store) to a mapping service. The mapping service may identify areas that include all three POIs in proximity. Each identified area containing all three POIs may be considered a cluster, and the clustered location data may be considered the location data of the POIs in each cluster.

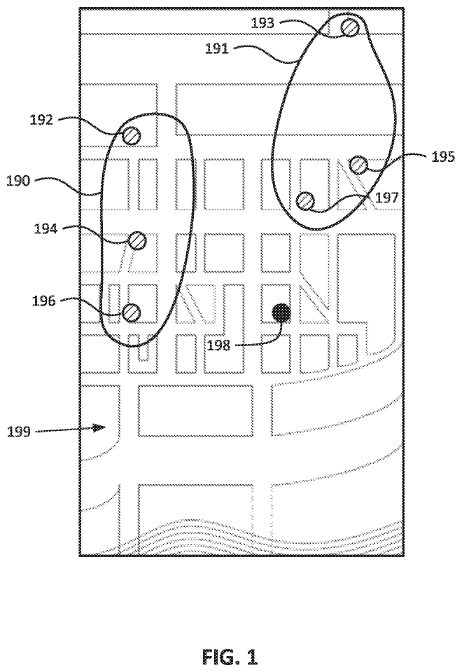

For example, FIG. 1 illustrates the locations of six POIs, including POI locations 192-197 overlaid on a map 199. POI locations 192 and 195 correspond to locations of a grocery store, POI locations 194 and 193 correspond to locations for gas stations, and POI locations 196 and 197 correspond to locations for department stores. The mapping service may determine that POI locations 192, 194, and 196, for the grocery store, gas station, and department store, respectively, are in close proximity and near a base location 198. Accordingly, the mapping service may cluster the POI locations into a first cluster 190. Similarly, the mapping service may determine that POI locations 193, 195, and 197, for the gas station, grocery store, and department store, respectively, are in close proximity and near base location 198. Accordingly, the mapping service may cluster the POI locations into a second cluster 191.

The mapping system may identify clusters of POIs by determining the locations of the POIs searched. Continuing the example, the mapping system may identify all grocery stores, gas stations, and department stores within a predefined radius of the user's location. For each POI, the mapping system may determine the distances to the locations of the other POIs. For instance, for each gas station, the mapping system may determine the distance to each identified grocery store and department store. This process may iterate until the distance between all gas stations, grocery stores, and department stores is determined. The mapping system may then group the POIs with the shortest distances between their locations into clusters containing one of each of the POIs searched (e.g., one gas station, one grocery store, one department store).

As used herein, points of interest may include any place or location. Examples of POIs include businesses, such as restaurants, shops, or service providers such as auto shops, hotels, gas stations, and electric vehicle charging stations. Additional examples include natural landmarks, parks, public service providers such as police stations or post offices, and civil service locations, such as municipal buildings. Moreover, POIs can include any real-world entity with a physical address, including non-business structures such as residences.

The technology described herein provides maps showing areas where queried POIs are in proximity to each other. As the queried POIs are different to each other, the technology described beneficially provides a map area in which the queried POIs are most closely clustered, be that by time and/or distance, meaning that the provided map area is optimized for the user. Additionally, the technology described herein avoids the need for a user to manually review a map to identify, using separate POI queries, where POIs they are interested in are located relative to each other.

Additionally, the technology described herein may provide a more efficient route by reducing the amount of time a user needs to travel to locations and/or by reducing the total distance traveled to visit each location (e.g., by providing location(s) that have each requested POI (clusters) that are close to a base location or are quickly accessed from the base location. By providing clusters, with clustered location data as described herein, a user may spend less time traveling, which in turn may reduce travel cost and the user's environmental footprint, as well as time savings for the user. Further yet, by providing clusters, traffic conditions may improve as users may take more efficient paths to the requested POIs, thereby reducing the time and distance the user is traveling.

In some instances, a POI can be associated with more than a singular location, such as latitude/longitude coordinates. In this regard, POIs may be associated with many locations or, in some instances, 3D geometry. In this regard, POIs may not be points but may include many locations, such as, for example, a business occupying a building, part of a building, or entire grounds. Further, POIs can be parts of larger, aggregating POIs. For example, each store in a mall may constitute a respective POI, and the mall may be a POI that aggregates each store in the mall.

### Example Systems

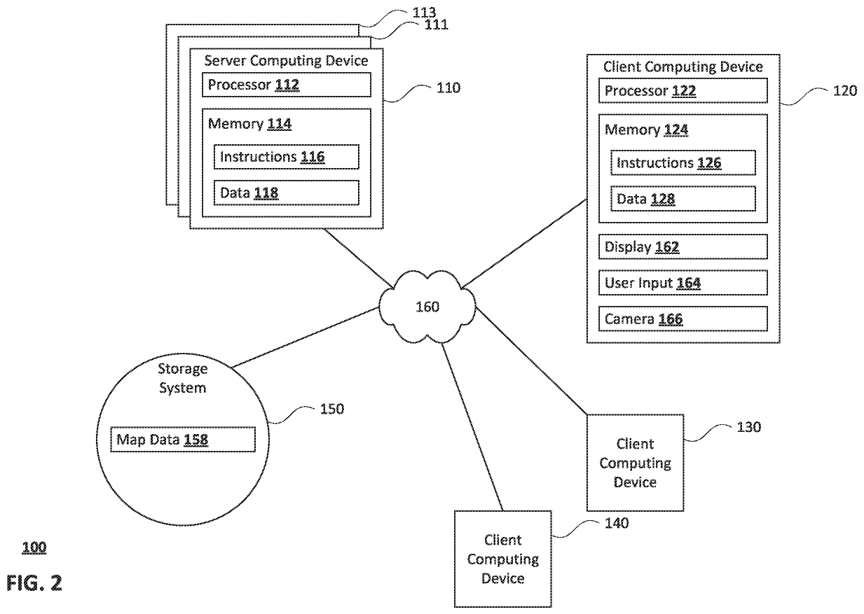

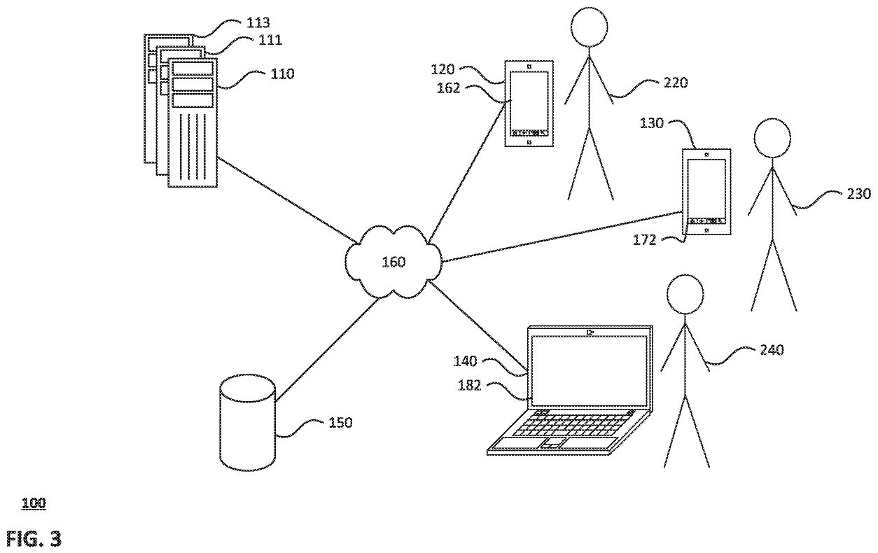

FIGS. 2 and 3 illustrate an example system 100 in which the features described above may be implemented. The system 100 should not be considered as limiting the scope of the disclosure or usefulness of the features described herein. As illustrated, system 100 includes computing devices 110, 111, 113, 120, 130, 140, and storage system 150. Each computing device, 110, 111, 113, 120, 130, 140 can contain one or more processors, memory, and other components typically present in general-purpose computing devices. For example, server computing device 110 includes processor 112 and memory 114. Memory 114 can store information accessible by the processor 112, including instructions 116 that can be executed by the processor 112. Server computing devices 111 and 113 may be configured similarly to server computing device 110, although the components within server computing devices 111 and 113 may differ from each other and server computing device 110.

As used herein, the term “computing device” may refer to either “server computing device” or “client computing device,” unless otherwise stated. The terms “server” and “server computing device” may be used interchangeably. Similarly, the terms “client computing device,” “client computer,” and “user device” may be used interchangeably.

Memory 114 can also include data 118 that can be retrieved, manipulated, or stored by the processor. The memory can be of any type, optionally a non-transitory type, capable of storing information accessible by the processor, such as a hard drive, memory card, ROM, RAM, DVD, CD-ROM, write-capable, and read-only memories.

Instructions 116 can be any set of instructions to be executed directly, such as machine code, or indirectly, such as scripts, by the processor 112. In that regard, the terms “instruction,” “application,” “step,” and “program” can be used interchangeably herein. The instructions can be stored in object code format for direct processing by a processor or in any other computing device language, including scripts or collections of independent source code modules that are interpreted on demand or compiled in advance. The functions, methods, operations, and routines of the instructions are explained in more detail below.

Data 118 may be retrieved, stored, or modified by processor 112 in accordance with instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII, or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The processor 112 can be any conventional processor, such as a commercially available CPU. Alternatively, the processor can be dedicated components such as an application-specific integrated circuit (“ASIC”) or other hardware-based processors. Server 110 may include any number of processors, although only a single processor is illustrated in FIG. 2. Although not necessary, server 110 may include specialized hardware components, such as hardware accelerators, to perform specific computing processes and functions, such as decoding video, matching video frames with images, distorting videos, encoding distorted videos, machine learning, machine perception, logo recognition, visual text transcription, semantic segmentation, and other such processes and machine learning faster or more efficiently.

Client computing devices 120, 130, and 140 may be configured similarly to the server computing device 110. For instance, client computing device 120 includes processors 122, memory 124, and instructions 126 as described above. Client computing devices 130 and 140 may be configured similarly to client computing device 120, although the components within client computing devices 130 and 140 may differ from each other and from client computing device 120.

Client computing devices 120, 130, and 140 may be personal computing devices intended for use by users 220, 230, and 240, respectively, as illustrated in FIG. 3. Each client computing device may have all of the components normally used in connection with a personal computing device. For instance, and as illustrated in FIG. 2, client computing device 120 includes processor 122, which may be a central processing unit (CPU), memory 124 (e.g., RAM and internal hard drives) storing data 128 and instructions 126, a display 162, a user input device 164, and a camera 166. Although client computing device 120 is illustrated with only one processor, display, user input device, and camera in FIG. 2, client computing device 120 may include any number of processors, displays, user input devices, and cameras.

Although the client computing devices 120, 130, and 140 may each comprise a full-sized personal computing device, they may alternatively comprise mobile computing devices capable of wirelessly exchanging data with servers over a network such as the Internet. By way of example only, client computing devices 120 and 130 may be mobile phones, and client computing device 140 may be a laptop, as illustrated in FIG. 3. In some instances, client computing devices 120, 130, and 140 may be devices such as wireless-enabled PDAs, tablet PCs, netbooks, head-mounted computing systems, vehicle computer systems, wearable devices (e.g., smartwatch) or any other such computing device.

Displays may be any device operable or otherwise capable of displaying information, such as a monitor having a screen, a touch-screen, a projector, a television, or other such devices. As illustrated in FIG. 3, client computing device 120 includes touch-screen display 162, and client computing device 130 includes touch-screen display 172. The client computing device 140 includes a monitor 182.

User input devices may be any device through which a user can interact with or provide data to a computing device. For instance, user input device 164 of client computing device 120 may be one or more of a mouse, keyboard, keypad, touch-screen, microphone, pen, etc. Client computing device 120 also includes a camera 166, another type of user input device, for recording video streams, capturing images, or both. Although not shown, client computing device 120 may also include speakers, a network interface device, and all of the components used for connecting these elements to one another. Server computing device 110 may also include some or all of the components normally used in connection with a personal computing device.

Although FIG. 2 functionally illustrates the processor, memory, and other elements of computing devices 110 and 120 as being within the same block, respectively, the processor, memory, and other elements can actually comprise multiple processors, memories, or other elements that may or may not be stored within the same physical housing. For example, the memory 114 of server computing device 110 can be a hard drive or other storage media, such as RAM, located in one or more housings different from that of the other components of server computing device 110, such as processors 112. Accordingly, references to a processor, memory, or other elements of the computing devices will be understood to include references to a collection of processors, memories, or elements that may or may not operate in parallel. Moreover, each computing device may be comprised of multiple computing devices. For example, each server computing device 110 may include multiple server computing devices operating as a load-balanced server farm, distributed system, etc. Yet further, although some functions described below are indicated as taking place on a single computing device having a single processor, various aspects of the subject matter described herein can be implemented by a plurality of computing devices working in cooperation by, for example, communicating information over network 160, as described herein.

Each of the computing devices 110, 111, 113, 120, 130, and 140 can be at different nodes of a network 160 and capable of directly and indirectly communicating with other nodes of network 160. Although only computing devices 110, 111, 113, 120, 130, and 140 are depicted in FIGS. 1-2, it should be appreciated that fewer or more computing devices may be possible. In this regard, a typical system can include a large number of connected computing devices, with each different computing device being at a different node of the network 160.

The network 160 and intervening nodes described herein can be interconnected using various protocols and systems, such that the network can be part of the Internet, World Wide Web, intranets, wide area networks, or local networks. The network can utilize standard communications protocols and systems, such as Ethernet, Wi-Fi, Bluetooth, and HTTP, protocols that are proprietary to one or more companies, and various combinations of the foregoing. Although certain advantages are obtained when information is transmitted or received, as noted above, other aspects of the subject matter described herein are not limited to any particular manner of transmission of information.

As an example, each server computing device 110, 111, and 113 may be configured to communicate with storage system 150 as well as client computing devices 120, 130, and 140 via the network 160. For example, one or more server computing devices 110, 111, and 113 may use network 160 to transmit and present information to a user, such as any of users 220, 230, or 240, on a display, such as one of the displays 162, 172, or 182 of computing devices 120, 130, or 140. Although the foregoing example illustrates the server computing devices communicating with client computing devices via network 160, the server computing devices may also communicate with other server computing devices. Similarly, client computing devices 120, 130, and 140 may communicate with server computing devices and client computing devices.

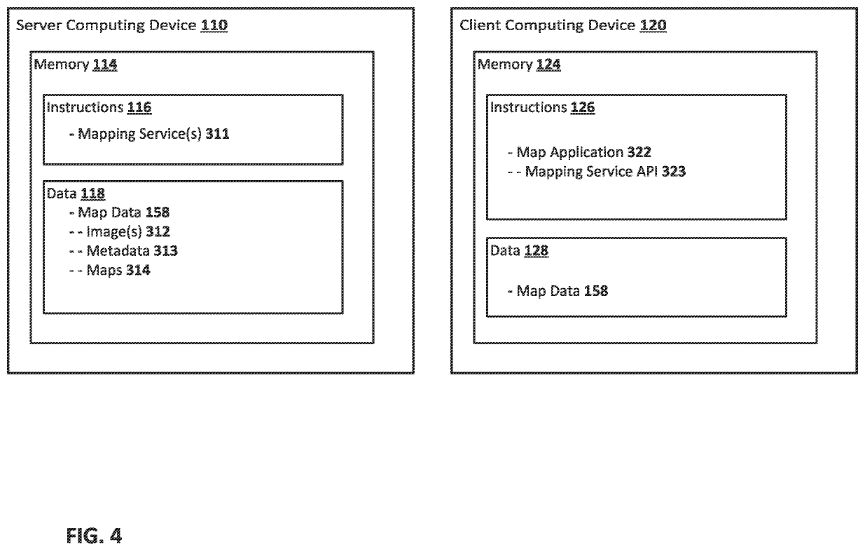

FIG. 4 illustrates example data and instructions that may be stored in the memory of server computing device 110 and client computing device 120. As shown, server computing device 110 includes memory 114 that stores instructions 116, including mapping services, and data 118, which includes map data 158.

Map data 158 may include data related to points of interest for retrieval in response to queries for information regarding those POIs, as described herein. In this regard, map data is typically maintained by a mapping service and supplied to users via a map application, a web browser, or other such applications in response to queries. However, map data may be maintained by any entity, business, individual, or combination thereof and is not limited to mapping services.

As illustrated in FIG. 4, map data 158 may include maps, images, and metadata associated with one or more POIs. Maps 314 may include political maps, climate maps, physical maps, thematic maps, topographic maps, road maps, or any other such maps or combination of maps. Images 312 within the map data may include photos of POIs, photos of objects and individuals captured at or near the POI, or any other images which may have some association or relation with the POI. For example, photos may include satellite imagery, street-level imagery, and user-provided imagery. As used herein, images 312 may include photographs, screenshots, videos, including video clips and video stills (e.g., frames) or any other such visual data, including actively-lit or passive non-visible band imagery such as LiDAR, radar, or infrared, taken from any perspective, such as ground level, aerial, satellite, etc. In this regard, images may be captured by cameras, video cameras, sensors, such as LiDAR, radar, and infrared sensors, or other such devices.

Metadata 313 within the map data may include any data that may be relevant to one or more points of interest within the map data or other such data that contains information that may be provided or otherwise referenced by a mapping service, stand-alone map application, or other such application that provides map information or services in response to a search query. Metadata 313 may also include other data such as information related to images within the map data, virtual tours of locations, business listings, business information, three-dimensional models of locations, real-time navigation, and real-time traffic conditions, POI busyness information (i.e., the amount of traffic/use of a POI at particular times/periods of time; e.g., a deli POI is very busy from 11 am to 2 pm (lunch time), but less busy from 7 am to 11 am and 2 pm to 6 pm), among other information and services. The metadata 313 may also include data about the images stored in the map data, such as image data including any or all of the date, time, and location the images were captured, the user ID of a user who provided the images, the name of the images, and text/objects identified in the images, as described further herein.

Images 312 and metadata 313 may be used to construct maps 314. In this regard, although images 312, metadata 313, and maps 314 are shown as separate components of map data 158, the components may overlap or be combined. For instance, an image 312 may be a map 314. In another example, an image 312 and metadata 313 may be combined to construct a map 314.

The mapping services 311 are services provided by a mapping service provider. The services provided by mapping services 311 may include providing map data, virtual tours of locations, business listings, business information, three-dimensional models of locations, real-time navigation, and real-time traffic conditions, POI busyness information, among other information and services. Mapping services 311 may include providing clustered location data, as further described herein.

The mapping services 311 may be provided to a map application, such as map application 322 executing on client computing device 120. In such a scenario, the map application 322 may communicate with the mapping services 311 through a network, such as network 160. In some instances, mapping services 311 may be provided to a client computing device through a web browser or web application. In this regard, a user, such as user 220, may access the mapping services by visiting a web address associated with the mapping services 311. Communication between the map application 322, web browser, or web application within the mapping services 311 may be through mapping service APIs 323.

With reference to FIGS. 1 and 2, storage system 150 can be of any type of computerized storage capable of storing information accessible by the server computing devices 110, such as a hard drive, memory card, ROM, RAM, DVD, CD-ROM, write-capable, and read-only memories, or any combination thereof. In addition, storage system 150 may include a distributed storage system where data is stored on a plurality of different storage devices, which may be physically located at the same or different geographic locations. Storage system 150 may be connected to the computing devices via the network 160, as shown in FIG. 2, directly connected to any of the computing devices 110, 111, 113, 120, 130, and 140 (not shown), or some combination of network and direct connections.

Although FIG. 2 illustrates map data 158 as being stored in storage system 150, the map data 158, or other such storage structures, may be stored, in full or in part, in any computing device or other storage system. For instance, client computing device 120 may store a local copy of a portion of map data in the data 128 stored in memory 124, as illustrated in FIG. 4. In another example, server computing device 110 may store a full copy of map data in the data 118 of memory 114, as further illustrated in FIG. 4. Alternatively or additionally, the map data may be stored across multiple computing devices or storage systems. In this regard, portions of map data that make up the entirety of the map data 158 may be stored on different storage devices or computing devices. Further, map data 158 may be stored as discrete or integrated portions of a larger database.

### Example Methods

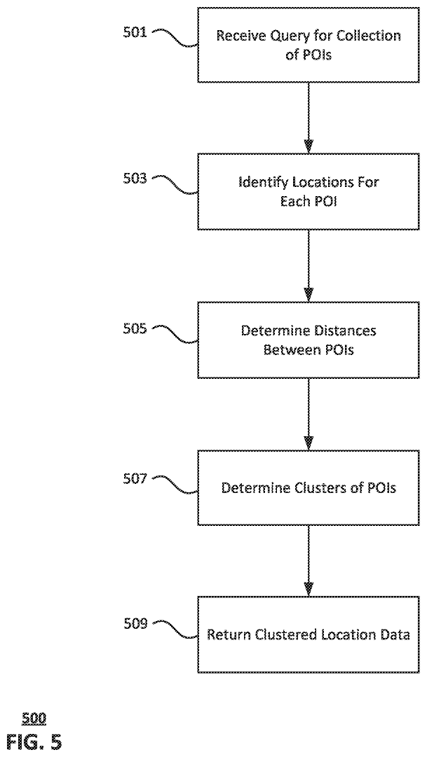

FIG. 5 is a flow diagram 500 that illustrates the process for providing clustered search results for different points of interest. As illustrated in block 501, a mapping service, such as mapping service 311, may receive a search query for a collection of POIs. The search query may include specific POIs and/or POI categories. As used herein, “specific POIs” means particular points of interest. For example, a specific POI may be a particular brand of gas station or a unique gas station (e.g., the “tiger” gas station on main st.) In another example, a specific POI may be a particular park or monument. “POI categories” means POIs corresponding to a particular class. For example, “department stores” may define a category of POIs, including all department stores regardless of the brand, owner, etc. Similarly, “a park” may define a category including all parks.

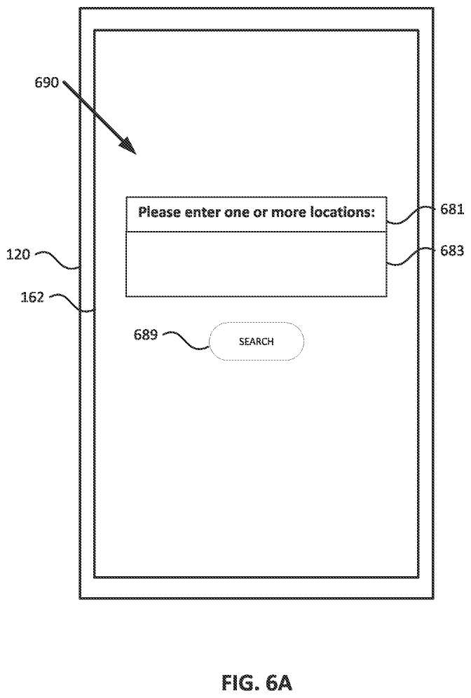

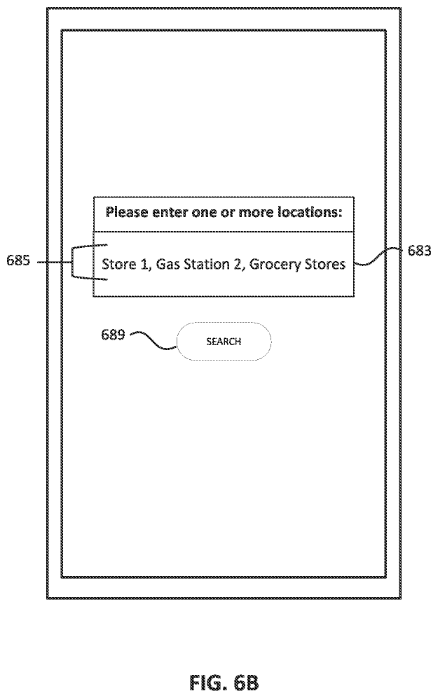

FIG. 6A illustrates a user interface 690 of a map application, such as map application 322, displayed on touchscreen 162 of client computing device 120. The user interface 690 includes a prompt 681, an input 683 where a user may enter a search query, and a search button 689. The text of the prompt 681 in FIG. 6A is merely for illustration. The prompt 681 may include any text. In some instances, a prompt may not be provided.

A user may input a search query for a collection of POIs into the input 683. As illustrated in FIG. 6B, the search query 685 includes “Store 1, Gas Station 2, Grocery Stores.” Upon selecting the search button 689, the map application may forward the search query 685 to the mapping service 311. “Store 1” and “Gas Station 2” are specific POIs and “Department Stores” is a POI category. Although FIGS. 6A and 6B illustrate the search query 685 being entered as text, the search query may be an audio query spoken by the user or any other type of query. Moreover, although the search query 685 includes three POIs, the search query 685 may include any number of POIs. However, if only a single POI is searched, a cluster will not be returned by the mapping service.

As illustrated in block 503, the mapping service 311 may identify locations for each POI included in the search query 685. The mapping service 311 may limit the area in which the locations for each POI are identified, referred to as the “area” or “searchable area” herein. For example, the mapping service may identify POIs only if they are within a searchable area, including geographic areas within a predefined threshold distance from a base location. The base location may be the location of the user's device. The predefined threshold distance may be defined by mapping service 311 or transmitted to the mapping service by the map application 322. In some instances, the user may input the predefined threshold distance into the map application 322. The map application may transmit the predefined threshold distance to the mapping service 311.

In some instances, the user may provide the mapping service 311 with a base location via the map application 322. For example, the user may want to identify a collection of POIs near a hotel they will be staying in on an upcoming vacation. In this case, the user may provide the base location as the hotel, and the mapping service will search for the collection of POIs within a predefined distance or particular area near the hotel. The base location may be provided in or otherwise with the search query. In some instances, the base location may be provided separately from the search query.

In some instances, the user may provide a searchable area within which the mapping service 311 should identify POIs. In this regard, the user may indicate an area such as a region, country, state, city, town, zip code, etc., in which they want to identify POIs. In another example, the user may draw or otherwise provide a searchable area on a map. The searchable area may be transmitted to the mapping service 311 via the map application 322, such as in or with the search query. In some instances, the searchable area may be provided separately from the search query. The mapping service 311 may limit the search for POI locations to the searchable area provided by the user.

By limiting the searchable area, the mapping service 311 is required to identify locations of POIs, the number of locations that need to be identified by the mapping service 311 may be reduced, thereby saving processing and time.

Alternatively, or in addition to limiting the area of the search by the mapping service, the total number of POI locations identified may be limited. For instance, the mapping service 311 may identify up to a preset number of POI locations, such as 10, 20, 50, 100, etc. The preset number of POI locations may be defined by the mapping service 311 or map application 322 or be provided by a user.

In some instances, the preset number of POI locations may be limited based on the number of POIs within a search query. In this regard, the preset number of POI locations identified by the mapping service may be limited to a multiple of the number of POIs in the query. For example, if 5 POIs are included in a search query and the multiple is 5, the maximum number of POI locations identified by the mapping service 311 will be 25. The multiple may be defined by the mapping service 311, map application 322, or the user and may be any number.

The number of POI locations identified by the mapping service 311 may, alternatively or additionally, be limited by the number of POIs within the area being searched. In this regard, a more densely populated area or a larger area may have more POIs than can be presented in an intelligible and/or visually pleasing format to a user on a map. As such, the number of identified POI locations in the densely populated or large area may be limited based on the total number of POIs in the area and/or the size of the area.

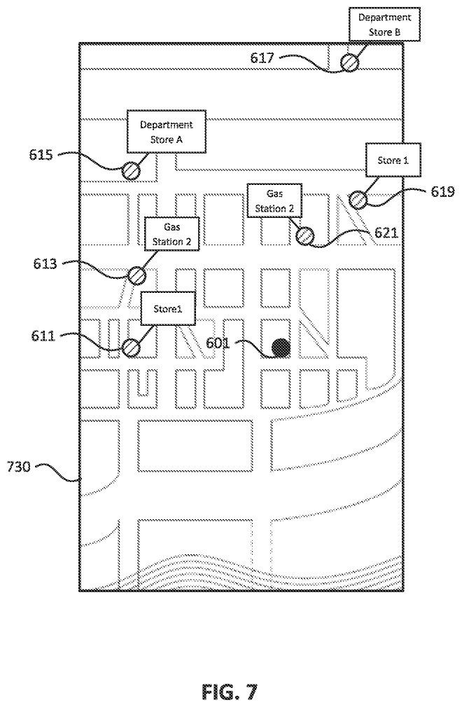

FIG. 7 illustrates the locations of each POI location identified by the mapping service 311 within area 730. For reference, the base location is 601. As illustrated in FIG. 7, the mapping service identified two “Store Is” POI locations 611, 619; two “Gas Station 2s” POI locations 613, 621; and two “Department Stores,” POI locations, including Department Store A location 615 and Department Store B location 617. Department Store A and Department Store B are different brand department stores.

As illustrated in block 505, the mapping service may determine the distances between each identified POI location of different types. For example, the mapping service 311 may determine the distance between the location of Store 1 619 and the locations of each of Department Store A 615, Department Store B 617, Gas Station 2 613, and Gas Station 2 621. As Store 1 611 is the same POI type as Store 1 619, the mapping service may not determine this distance, as Store 1 611 and Store 1 619 cannot be in the same cluster since the search request is only for a single Store 1. The mapping service 311 may iterate this process for each identified POI location until the distances between all different types of POI locations are determined.

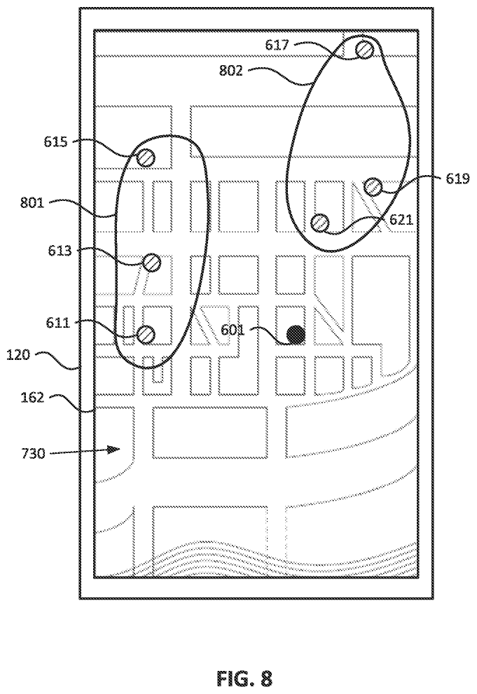

As illustrated in block 507, the mapping system may then determine clusters of POI locations that satisfy the search query 685. In this regard, the mapping system may identify clusters of POIs that have locations with the shortest distance between themselves and that include one of each of the POIs searched (e.g., one gas station, one grocery store, one department store). For instance, and as shown in FIG. 8, a first cluster identified by the mapping service 311 includes the locations for Store 1 611, Gas Station 2 613, and Department Store A 615. Second cluster identified by the mapping service 311 includes the locations for Store 1 619, Gas Station 2 621, and Department Store B 617.

In some instances, clusters may include one or more of the same POI locations. For example, a user may submit a search query for Gas Stations and Department Store C. In this case, the mapping service may identify clusters that each include Department Store C, but each has a different Gas Station. In some instances, the mapping service may limit the number of clusters identified. By limiting the number of clusters identified, the mapping service 311 may reduce the processing and time needed to determine clusters.

After determining the clusters of POIs, the mapping service 311 may return clustered location data to the map application 322, as shown in block 509. The clustered location data includes, for each identified cluster, the location data of the POIs in each cluster. In some instances, the mapping service 311 may provide only a subset of the identified clusters. For instance, the mapping service 311 may provide only a predefined number of clusters or the clusters closest to the user's location or the base location or clusters which are most quickly accessed from the user's location or the base location. Optionally, the mapping service 311 may provide only those clusters for which the maximum distance between the furthest away POI of the cluster and the base station 601 is below a certain distance threshold. Such a distance threshold may be set by the user, by the mapping service 311 itself, or by some other means. Beneficially, the user may specify a maximum distance they're willing to travel as the distance threshold.

Upon receiving the clustered location data, the map application 322 may provide a visual representation of the clustered location data on a map. For instance, and as illustrated in FIG. 8, the map application 322 may present on the user display 162 of the client device 120 a map of area 730 around the base location 601. The clustered location data includes POI locations 611, 613, 615, 617, 619, 621, which are identified by markings on the map. Cluster outlines 801 and 802 illustrate the first and second clusters, respectively. Each cluster outline surrounds the POI locations within each cluster. In this regard, POI locations 611-615 are in the first cluster and are surrounded by cluster outline 801. POI locations 617-621 are in the second cluster and are surrounded by cluster outline 802. Although cluster outlines 801 and 802 are illustrated as generally oval, cluster outlines may be any shape.

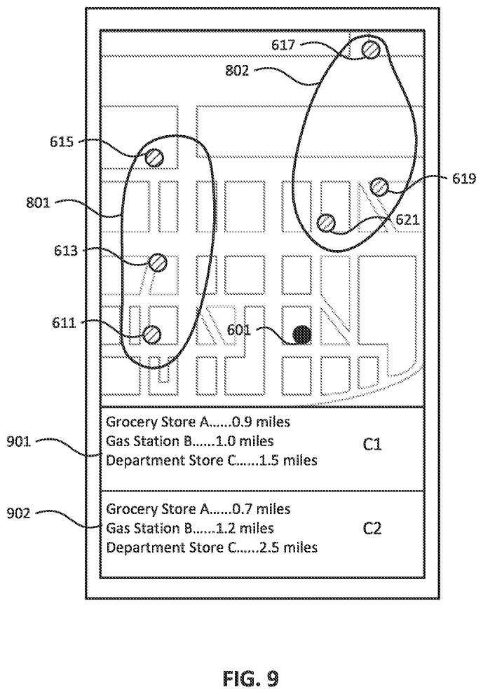

FIG. 9 illustrates a user interface similar to that of FIG. 8, but with additional cluster location data contained in sub-sections 901 and 902. In this regard, the sub-sections are each associated with a cluster. The sub-sections each provide details about the POI locations within their associated cluster. For example, sub-section 901 includes information about POIs 611, 613, and 615, including the distance of each POI location from base location 601. Sub-section 902 includes information about POIs 617, 619, and 621 and the distance of each POI location from base location 601. Other information, such as the distance between each POI location in a cluster, may also be presented in the sub-sections.

In some instances, the mapping system may provide directions to each POI in a cluster. For instance, the mapping system may provide directions to a first POI in a cluster and then to other POIs in the cluster. For example, referring to FIG. 8, a user may select the first cluster and be provided with directions to POI locations 611, 613, and 615. The directions provided to the POIs in the cluster may be based on traffic conditions and other factors to minimize the travel time of the user and/or distance the user will need to travel to visit the POIs in the cluster. For example, POI location 611 may be on a road experiencing rush hour traffic. As such, the mapping system may provide directions that recommend the user travel from base location 601 to POI location 613, and then from POI location 613 to POI location 615, and then finally, from POI location 615 to POI location 611. By providing directions to POI location 611 last, the user may avoid rush hour traffic on the road POI location 611 is located.

Although not shown, the user interface may include the ability to provide additional clusters. For instance, if the mapping service returns the clustered location data for four clusters, the user interface may present two clusters. The user interface may then allow the user to switch to the other two clusters. Additionally, the user interface may allow users to remove a cluster or create clusters.

The user interfaces illustrated in FIGS. 6A, 6B, 7, and 8 are example user interfaces. It will be understood that the technology described herein can be implemented on other user interfaces with the same or different design elements.

Although the foregoing examples describe the user interacting with the mapping service 311 via the map application 322, it should be understood that each function, operation, etc., of the map application 322 may be implemented by a web browser, web application, or any other application. Moreover, although the preceding examples describe functions, operations, etc., being performed by the mapping service 311 and the map application 322, each function, operation, etc., may be performed by any application or service. For example, the map application 322 may be a stand-alone application capable of performing the functions, operations, etc., of the mapping service 311, including identifying the location for each POI, identifying distances between POIs, determining clusters of POIs, etc.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this disclosure, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

With respect to the use of substantially any plural and/or singular terms herein, for example (with the term “element” being a stand-in for any system, component, data, etc.) “an/the element,” “one or more elements,” “multiple elements,” a “plurality of elements,” “at least one element,” etc., those having skill in the art can translate from the plural to the singular and/or from the singular to the plural as is appropriate to the context and/or application described. The various singular/plural permutations may be expressly set forth herein, for sake of clarity and without limitation unless expressly indicated.

1. A method for clustering points of interest (POIs), the method comprising:
receiving, by one or more processors, a search query for a collection of POIs;
identifying, by the one or more processors, one or more locations for each POI in the collection of POIs;
determining, by the one or more processors, based on the one or more locations for each POI in the collection of POIs, distances between each POI;
determining, by the one or more processors, based on the distances between each POI, one or more clusters of POIs; and
transmitting, by the one or more processors, clustered location data, the clustered location data including, for each of the one or more clusters of POIs, the location of each POI in the cluster.

2. The method of claim 1, wherein the search query includes one or more specific POIs or POI categories.

3. The method of claim 1, wherein identifying the one or more locations for each POI in the collection of POIs is limited to a searchable area.

4. The method of claim 3, wherein the searchable area includes geographic areas within a predefined threshold distance from a base location.

5. The method of claim 4, wherein the search query is provided by a user device, and wherein the base location is a location of the user device.

6. The method of claim 4, further comprising:
receiving, prior to identifying the one or more locations for each POI in the collection of POIs, the base location.

7. The method of claim 3, further comprising:
receiving, prior to identifying the one or more locations for each POI in the collection of POIs, the searchable area.

8. The method of claim 7, wherein the searchable area includes a region, country, state, city, town, zip code, or an area drawn on a map.

9. The method of claim 1, wherein the one or more locations for each POI in the collection of POIs is limited to a set amount of locations.

10. A system, comprising:
one or more processors configured to:
receive a search query for a collection of POIs;
identify one or more locations for each POI in the collection of POIs;
determine, based on the one or more locations for each POI in the collection of POIs, distances between each POI;
determine, based on the distances between each POI, one or more clusters of POIs; and
transmit clustered location data, the clustered location data including, for each of the one or more clusters of POIs, the location of each POI in the cluster.

11. The system of claim 10, wherein the search query includes one or more specific POIs or POI categories.

12. The system of claim 10, wherein identifying the one or more locations for each POI in the collection of POIs is limited to a searchable area.

13. The system of claim 12, wherein the searchable area includes geographic areas within a predefined threshold distance from a base location.

14. The system of claim 13, wherein the search query is provided by a user device, and wherein the base location is a location of the user device.

15. The system of claim 13, wherein the one or more processors are further configured to:
receive, prior to identifying the one or more locations for each POI in the collection of POIs, the base location.

16. The system of claim 12, wherein the one or more processors are further configured to:
receive, prior to identifying the one or more locations for each POI in the collection of POIs, the searchable area.

17. The system of claim 16, wherein the searchable area includes a region, country, state, city, town, zip code, or an area drawn on a map.

18. The system of claim 10, wherein the one or more locations for each POI in the collection of POIs is limited to a set amount of locations.

19. A computer-readable storage medium storing instructions executable by one or more processors for performing a method, the method comprising:
receiving a search query for a collection of POIs;
identifying one or more locations for each POI in the collection of POIs;
determining, based on the one or more locations for each POI in the collection of POIs, distances between each POI;
determining, based on the distances between each POI, one or more clusters of POIs; and
transmitting clustered location data, the clustered location data including, for each of the one or more clusters of POIs, the location of each POI in the cluster.

20. The computer-readable storage medium of claim 19, wherein identifying the one or more locations for each POI in the collection of POIs is limited to a searchable area, and
wherein the searchable area includes geographic areas within a predefined threshold distance from a base location.
